(19) United States
(12) Patent Application Publication
(10) Pub. No.: US 2026/0034695 A1
(43) Pub. Date: Feb. 5, 2026

(54) SLITTING DEVICE FOR BATTERY POLE PIECES, AND METHOD THEREFOR

(71) Applicant: DONGGUAN ZHONGNENG PRECISION MACHINERY CO., LTD, DONGGUAN (CN)

(72) Inventors: WEN HU, DONGGUAN (CN); HAO DAI, DONGGUAN (CN); ANXI LU, DONGGUAN (CN)

(21) Appl. No.: 18/956,441

(22) Filed: Nov. 22, 2024

(30) Foreign Application Priority Data
Aug. 1, 2024 (CN) 202411051299.3

(51) Int. Cl. B26D 3/08

(52) U.S. Cl. CPC B26D 3/08

(57) ABSTRACT

A slitting device for battery pole pieces is provided, including an operating table; side supporting seats are respectively disposed at two sides of an upper end of a bottom plate, a rotatable transmission roller is provided between inner sides of the two side supporting seats, a liftable cross knife holder is disposed at upper ends of the two side supporting seats and is provided with a plurality of detachable mounting seats, and rotatable slitting knives are disposed at front ends of the mounting seats; an adjusting device is also disposed at the front end of each of the mounting seats and includes a rotatable second threaded rod; and the second threaded rods, when rotating, can form structures allowing the slitting knives to move left or right. Transmission structures can be independently dismounted, facilitating installation and later maintenance. The knife holder and the slitting knives can also be adjusted.

### TECHNICAL FIELD

The present disclosure relates to the technical field of battery pole piece manufacturing, and in particular to a slitting device for battery pole pieces, and a method therefor.

### BACKGROUND

A battery pole piece is the core and important part of a battery, which is divided into a positive pole piece and a negative pole piece. A lithium battery foil needs to be pre-slit into the desired shape during production of the battery pole piece. Pre-slitting is mainly used for high endurance and large width lithium battery foils. After products from a coating section process are rolled and stretched, large area materials are slit into the required shapes. At present, the existing pre-slitting machine still has many defects, such as: 1, the existing wide transmission structure is not conducive to installation and maintenance; 2, the adjustment of a knife holder is relatively single and lacks flexibility; and 3, during the use of the existing slitting knife, upper and lower knives are fixed together and thus cannot be adjusted. For these reasons, a slitting device for battery pole pieces is designed to solve the above-mentioned problems.

### SUMMARY

In view of problems that existing equipment is not conducive to installation and maintenance, with poor adjustment flexibility, a slitting device for battery pole pieces is provided, which enables all transmission structures to be independently dismounted so as to facilitate installation and later maintenance, and can also adjust a knife holder and slitting knives at multiple degrees of freedom, thus effectively solving the problems mentioned in the Background.

The present disclosure adopts the following technical solutions to solve the above problems.

A slitting device for battery pole pieces includes a bottom plate, where side supporting seats are respectively disposed at two sides of an upper end of the bottom plate, a rotatable transmission roller is provided between inner sides of the two side supporting seats, and a liftable cross knife holder is disposed at upper ends of the two side supporting seats; the cross knife holder is provided with a plurality of detachable mounting seats, and rotatable slitting knives are disposed at front ends of the mounting seats; an adjusting device is also disposed at the front end of each of the mounting seats and includes a rotatable second threaded rod; and the second threaded rods, when rotating, can form structures allowing the slitting knives to move left or right.

Side frames are fixedly connected to left and right sides of upper end surfaces of the side supporting seats, respectively; the cross knife holder is slidably connected to inner walls of the two side frames; rear end surfaces of the side frames are also fixedly connected to second motors, respectively; output ends of the second motors are fixedly connected to first threaded rods, respectively; and the cross knife holder is in threaded connection with outer surfaces of the two first threaded rods.

A third motor is fixedly connected to a front end surface of each of the mounting seats; the second threaded rods are fixedly connected to output ends of the corresponding third motors, respectively; sleeve boxes are respectively disposed at the front ends of the mounting seats, and driving boxes are respectively disposed at lower ends of the sleeve boxes; the slitting knives are respectively mounted at one sides of the driving boxes; and incomplete threaded seats cooperating with the second threaded rods are respectively provided on front and rear sides of an upper end of each of the sleeve boxes.

Spring seats are fixedly connected to front and rear sides of an upper end surface of each of the sleeve boxes, respectively; first springs are fixedly connected to end faces of inner sides of the two spring seats, respectively; the incomplete threaded seats are fixedly connected to inner side ends of the corresponding first springs, respectively; and the incomplete threaded seats are also slidably connected to the upper end surface of the sleeve box, respectively.

Extension seats are respectively disposed at upper ends of the driving boxes, the extension seats are slidably connected to inner walls of the sleeve boxes, respectively; transverse sliding blocks are fixedly connected to end faces of one sides of the extension seats, respectively; cross rails are slidably connected to the front end surfaces of the mounting seats, respectively; each of the transverse sliding blocks is slidably connected to the corresponding cross rail, and a vertical plate is fixedly connected to an upper end surface of each of the cross rails; the mounting seats are also provided with centrifugal devices cooperating with the vertical plates, respectively; the centrifugal devices are respectively connected to the second threaded rods; and the second threaded rods, when rotating, can form structures enabling the centrifugal devices to work to move the vertical plates and the slitting knives upward.

Each of the centrifugal devices includes an extension shaft fixedly connected to the corresponding second threaded rod, and connecting pads that can move left and right are respectively sleeved on outer surfaces of the extension shafts; connecting seats slidably connected to the mounting seats are rotatably connected to outer surfaces of the connecting pads, respectively; a connecting rod is fixedly connected to an end face of one side of each of the connecting seats, and first sliding pins are fixedly connected to inner walls of the connecting rods, respectively; and the vertical plates are respectively provided with track grooves cooperating with the first sliding pins.

First tension springs cooperating with the connecting pads are respectively sleeved on the outer surfaces of the extension shafts; a plurality of evenly distributed long connecting rods are respectively hinged on left end surfaces of the connecting pads; centrifugal discs are fixedly connected to the outer surfaces of the extension shafts, respectively; a plurality of evenly distributed sliding seats are slidably connected to inner walls of the centrifugal discs, respectively; and the long connecting rods are respectively hinged on the corresponding sliding seats, and centrifugal balls are fixedly connected to right ends of the sliding seats, respectively.

Tension spring seats are fixedly connected to the front end surfaces of the mounting seats, respectively; second tension springs are respectively and fixedly connected to end faces of one sides the tension spring seats, and the other ends of the second tension springs are fixedly connected to the corresponding sleeve boxes, respectively; long pins are respectively disposed at upper ends of the incomplete threaded seats; and two movable linkage frames are disposed at a front side of an upper end surface of the cross knife holder, and the linkage frames are respectively provided with elongated slots cooperating with the long pins.

A first motor is fixedly connected to a middle part of an upper end surface of the bottom plate, an output end of the first motor is fixedly connected to a disc, and a short pin is fixedly connected to a non-centered part of an upper end surface of the disc; a surrounding box is fixedly connected to inner walls of the two side supporting seats, and a scraper cooperating with the transmission roller is fixedly connected to an inner wall of the surrounding box; a guide plate cooperating with the surrounding box is slidably connected to the upper end surface of the bottom plate, and a long key plate cooperating the short pin is fixedly connected to a middle part of a lower end surface of the guide plate; and collection boxes cooperating with the guide plate are respectively placed on left and right sides of the upper end surface of the bottom plate.

A method for using the slitting device for battery pole pieces includes the following steps:
S1, placing a lithium battery foil to be slit between the transmission roller and the slitting knives, and allowing the lithium battery foil to be slit when the transmission roller and the slitting knives rotate to work; and
S2, when a slitting width needs to be changed, moving the slitting knives left or right to designated positions by rotating the second threaded rods, and obtaining the required slitting width when the slitting knives continue rotation to work.

Compared with the prior art, the present disclosure has the following advantages.

Ordinate positions of the slitting knives can be adjusted when the cross knife holder is raised and lowered, and the mounting seats are fixed onto the cross knife holder by means of bolts, which allows for independent disassembly of the mounting seats, the slitting knives and the like, thus facilitating installation and maintenance, reducing space occupation, lowering energy consumption, shortening mold changing time, and improving production efficiency. Due to arrangement of the adjusting devices, abscissa positions of the slitting knives can be adjusted according to the pre-slitting requirements, that is, the left and right process width dimensions can be adjusted independently. The slitting knives can rotate, and an outer surface of the transmission roller is provided with a plurality of knife grooves cooperating with the slitting knives. By allowing the lithium battery foil to pass through the position between the slitting knives and the transmission roller, the lithium battery foil can be slit under the cooperation of the slitting knives and the knife grooves. The device has a reduced structural space, is conducive to installation and maintenance, is simple in structure, saves materials, reduces energy consumption, and solves the problem that an all-in-one machine for pre-slitting wide foils is difficult to adjust. It can be independently disassembled for rapid tool and mold changing, thus shortening the mold changing time and improving the production efficiency.

### BRIEF DESCRIPTION OF FIGURES

FIG. 1 is a first axonometric view of a slitting device for battery pole pieces according to the present disclosure.

FIG. 2 is a second axonometric view of a slitting device for battery pole pieces according to the present disclosure.

FIG. 3 is a schematic diagram showing the installation of a transmission roller of a slitting device for battery pole pieces according to the present disclosure.

FIG. 4 is a schematic diagram showing the installation of a guide plate of a slitting device for battery pole pieces according to the present disclosure.

FIG. 5 is a schematic diagram showing the installation of a disc of a slitting device for battery pole pieces according to the present disclosure.

FIG. 6 is a schematic diagram showing the installation of linkage frames of a slitting device for battery pole pieces according to the present disclosure.

FIG. 7 is a schematic diagram showing the installation of a cross knife holder of a slitting device for battery pole pieces according to the present disclosure.

FIG. 8 is a schematic diagram showing the installation of a second threaded rod of a slitting device for battery pole pieces according to the present disclosure.

FIG. 9 is a schematic diagram showing the installation of incomplete threaded seats of a slitting device for battery pole pieces according to the present disclosure.

FIG. 10 is a schematic diagram showing the installation of a vertical plate of a slitting device for battery pole pieces according to the present disclosure.

FIG. 11 is a schematic diagram showing the installation of a first sliding pin of a slitting device for battery pole pieces according to the present disclosure.

FIG. 12 is a schematic diagram showing the installation of a centrifugal disc of a slitting device for battery pole pieces according to the present disclosure.

Description of reference numerals in figures: 1 denotes a bottom plate, 2 denotes side supporting seats, 3 denotes a transmission roller, 4 denotes a surrounding box, 5 denotes a scraper, 6 denotes a guide plate, 7 denotes limit seats, 8 denotes collection boxes, 9 denotes a first motor, 10 denotes a disc, 11 denotes a short pin, 12 denotes a long key plate, 13 denotes side frames, 14 denotes second motors, 15 denotes first threaded rods, 16 denotes a cross knife holder, 17 denotes mounting seats, 18 denotes driving boxes, 19 denotes protective covers, 20 denotes slitting knives, 21 denotes extension seats, 22 denotes transverse sliding blocks, 23 denotes sleeve boxes, 24 denotes spring seats, 25 denotes first springs, 26 denotes incomplete threaded seats, 27 denotes third motors, 28 denotes second threaded rods, 29 denotes long pins, 30 denotes telescopic rods, 31 denotes linkage frames, 32 denotes elongated slots, 33 denotes knife grooves, 34 denotes cross rails, 35 denotes vertical plates, 36 denotes connecting rods, 37 denotes first sliding pins, 38 denotes transverse slots, 39 denotes chutes, 40 denotes extension shafts, 41 denotes first tension springs, 42 denotes connecting pads, 43 denotes connecting seats, 44 denotes long connecting rods, 45 denotes sliding seats, 46 denotes centrifugal balls, 47 denotes centrifugal discs, 48 denotes second tension springs, and 49 denotes tension spring seats.

### DETAILED DESCRIPTION

Specific embodiments of the present disclosure are provided below to further describe the technical solution of the present disclosure in conjunction with the accompanying drawings, but the present disclosure is not limited to the following embodiments.

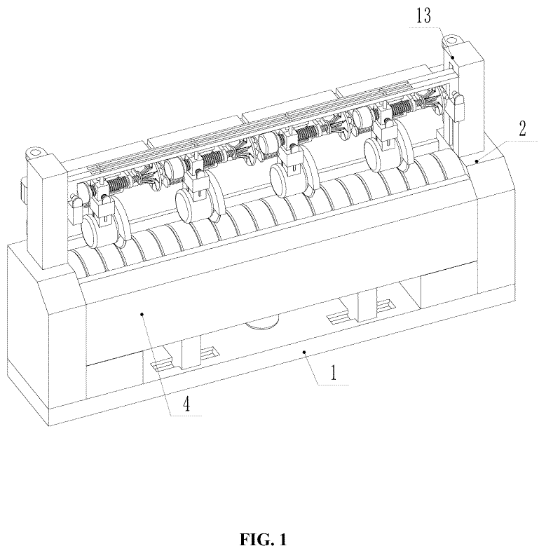

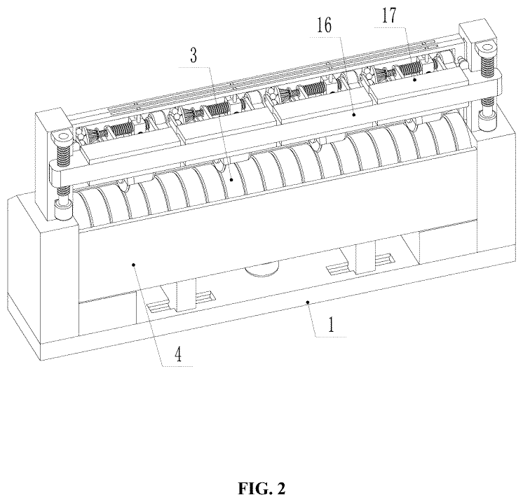

As shown in FIG. 1 to FIG. 12, the present disclosure provides a slitting device for battery pole pieces, including a bottom plate 1, where side supporting seats 2 are respectively disposed at two sides of an upper end of the bottom plate 1, a rotatable transmission roller 3 is provided between inner sides of the two side supporting seats 2, and a liftable cross knife holder 16 is disposed at upper ends of the two side supporting seats 2; the cross knife holder 16 is provided with a plurality of detachable mounting seats 17, and rotatable slitting knives 20 are disposed at front ends of the mounting seats 17; an adjusting device is also disposed at the front end of each of the mounting seats 17 and includes a rotatable second threaded rod 28; and the second threaded rods 28, when rotating, can form structures allowing the slitting knives 20 to move left or right.

As shown in FIG. 1 to FIG. 8, the bottom plate 1 is configured to support the whole device, the side supporting seats 2 are fixedly connected to an upper end surface of the bottom plate 1, the side supporting seats 2 are configured to support and limit the transmission roller 3 to ensure same to only rotate, a drive motor is disposed on an inner wall of each of the side supporting seats 2, the transmission roller 3 is fixedly connected to output ends of the drive motors, and the drive motors are configured to provide rotational power for the transmission roller 3. The motors belong to the prior art and will not be elaborated herein. The cross knife holder 16 is configured to support and fix the mounting seats 17, the slitting knives 20, the adjusting devices and other parts. Ordinate positions of the slitting knives 20 can be adjusted when the cross knife holder 16 is raised and lowered, and the mounting seats 17 are fixed onto the cross knife holder 16 by means of bolts, which allows for independent disassembly of the mounting seats 17, the slitting knives 20 and the like, thus facilitating installation and maintenance, reducing space occupation, lowering energy consumption, shortening mold changing time, and improving production efficiency. Due to arrangement of the adjusting devices, abscissa positions of the slitting knives 20 can be adjusted according to the pre-slitting requirements, that is, the left and right process width dimensions can be adjusted independently. The slitting knives 20 can rotate, and an outer surface of the transmission roller 3 is provided with a plurality of knife grooves 33 cooperating with the slitting knives 20. By allowing a lithium battery foil to pass through the position between the slitting knives 20 and the transmission roller 3, the lithium battery foil can be slit under the cooperation of the slitting knives 20 and the knife grooves 33. The device has a reduced structural space, is conducive to installation and maintenance, is simple in structure, saves materials, reduces energy consumption, and solves the problem that an all-in-one machine for pre-slitting wide foils is difficult to adjust. It can be independently disassembled for rapid tool and mold changing, thus shortening the mold changing time and improving the production efficiency.

Side frames 13 are fixedly connected to left and right sides of upper end surfaces of the side supporting seats 2, respectively; the cross knife holder 16 is slidably connected to inner walls of the two side frames 13; rear end surfaces of the side frames 13 are also fixedly connected to second motors 14, respectively; output ends of the second motors 14 are fixedly connected to first threaded rods 15, respectively; and the cross knife holder 16 is in threaded connection with outer surfaces of the two first threaded rods 15.

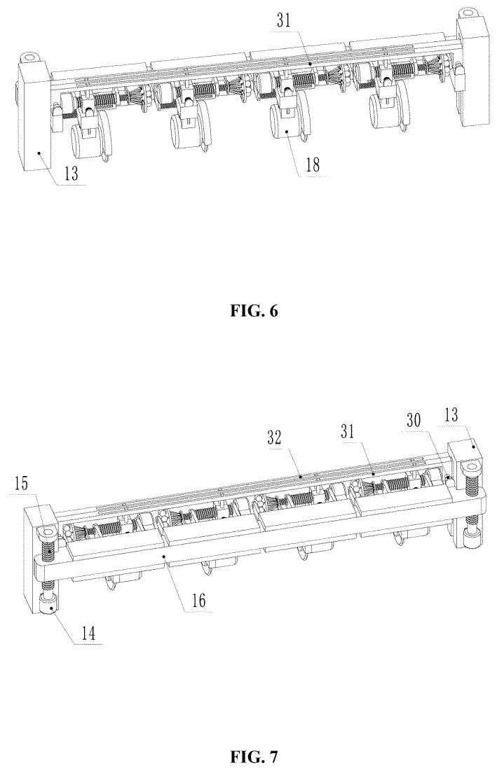

As shown in FIG. 6 and FIG. 7, the side frames 13 limit the cross knife holder 16 so as to allow the cross knife holder 16 to only move up and down; upper ends of the outer surfaces of the first threaded rods 15 are rotatably connected to bearing seats, and bottom ends of the bearing seats are fixedly connected to end faces of one sides of the side frames 13, respectively; the bearing seats are configured to limit the first threaded rods 15 to ensure same to only rotate; and the second motors 14 are configured to provide rotational power for the first threaded rods 15. The motors belong to the prior art and will not be elaborated herein. When the second motors 14 are started, they can drive the first threaded rods 15 to rotate. The first threaded rods 15, when rotating, will also drive the cross knife holder 16 to move upward or downward, thereby adjusting the ordinates of the cross knife holder 16 and the slitting knives 20. Furthermore, a self-locking function is also achieved under the threaded connection between the first threaded rods 15 and the cross knife holder 16, that is, when the first threaded rods 15 do not rotate, the positions corresponding thereto of the cross knife holder 16 are in a fixed state.

A third motor 27 is fixedly connected to a front end surface of each of the mounting seats 17; the second threaded rods 28 are fixedly connected to output ends of the corresponding third motors 27, respectively; sleeve boxes 23 are respectively disposed at the front ends of the mounting seats 17, and driving boxes 18 are respectively disposed at lower ends of the sleeve boxes 23; the slitting knives 20 are respectively mounted at one sides of the driving boxes 18; and incomplete threaded seats 26 cooperating with the second threaded rods 28 are respectively provided on front and rear sides of an upper end of each of the sleeve boxes 23.

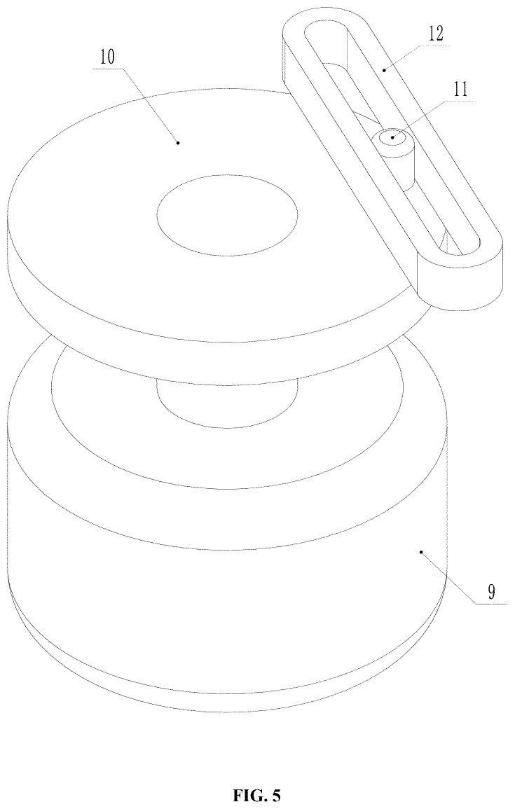

As shown in FIG. 5 to FIG. 7, the third motors 27 can provide rotational power for the second threaded rods 28; bearing seats are rotatably connected to one sides of outer surfaces of the second threaded rods 28, respectively; bottom ends of the bearing seats are fixedly connected to the mounting seats 17, respectively; the bearing seats are configured to limit and support the second threaded rods 28 to ensure same to only rotate; the sleeve boxes 23 are configured to support the parts such as the driving boxes 18 and the slitting knives 20; motors are disposed on inner walls of driving boxes 18, and the slitting knives 20 are mounted at output ends of the motors; the motors provide rotational power for the slitting knives 20; protective covers 19 cooperating with the slitting knives 20 are also disposed at one sides of driving boxes 18 to prevent the slitting knives 20 from being damaged or broken; when the third motors 27 are started, the second threaded rods 28 can be driven to rotate; and the second threaded rods 28, when rotating, will also cause the sleeve boxes 23, the driving boxes 18, the slitting knives 20, and the like to move left or right through the threaded connection with the incomplete threaded seats 26, thereby adjusting the positions of the slitting knives 20.

Spring seats 24 are fixedly connected to front and rear sides of an upper end surface of each of the sleeve boxes 23, respectively; first springs 25 are fixedly connected to end faces of inner sides of the two spring seats 24, respectively; the incomplete threaded seats 26 are fixedly connected to inner side ends of the corresponding first springs 25, respectively; and the incomplete threaded seats 26 are also slidably connected to the upper end surface of the sleeve box 23, respectively.

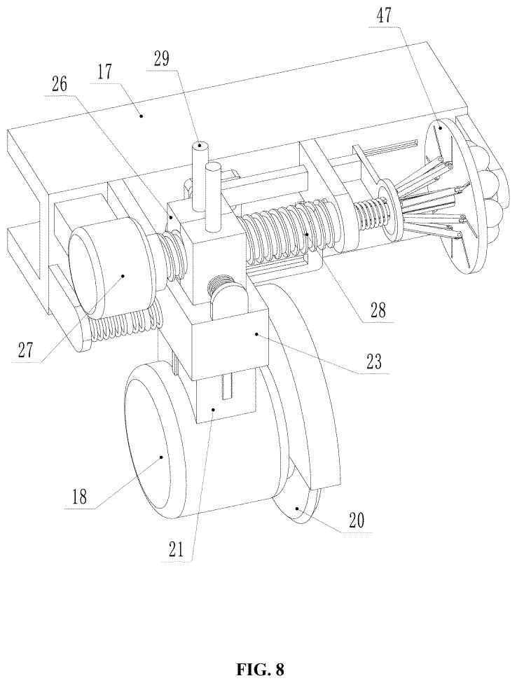

As shown in FIG. 8, the incomplete threaded seats 26 can slide back and forth on the upper end surfaces of the sleeve boxes 23. When the two incomplete threaded seats 26 move to the innermost end, they can engage with the second threaded rods 28. When the two incomplete threaded seats 26 move outward, they can disengage from the second threaded rods 28 and are no longer in threaded connected with the second threaded rods 28. The spring seats 24 are configured to support and fix the first springs 25. The first springs 25 are configured to drive the two incomplete threaded seats 26 with inward driving forces, so that the incomplete threaded seats 26 are enabled to be positioned at the innermost end under normal conditions, that is, stably engaged with the second threaded rods 28.

Extension seats 21 are respectively disposed at upper ends of the driving boxes 18, the extension seats 21 are slidably connected to inner walls of the sleeve boxes 23, respectively; transverse sliding blocks 22 are fixedly connected to end faces of one sides of the extension seats 21, respectively; cross rails 34 are slidably connected to the front end surfaces of the mounting seats 17, respectively; each of the transverse sliding blocks 22 is slidably connected to the corresponding cross rail 34, and a vertical plate 35 is fixedly connected to an upper end surface of each of the cross rails 34; the mounting seats 17 are also provided with centrifugal devices cooperating with the vertical plates 35, respectively; the centrifugal devices are respectively connected to the second threaded rods 28; and the second threaded rods 28, when rotating, can form structures enabling the centrifugal devices to work to move the vertical plates 35 and the slitting knives 20 upward.

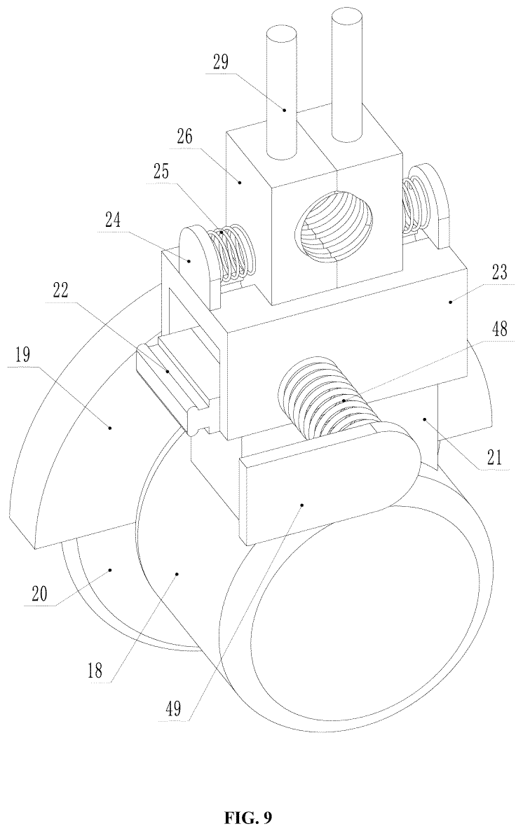

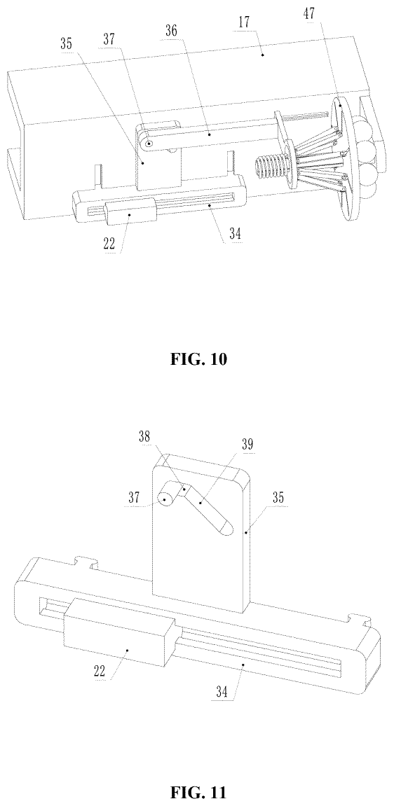

As shown in FIG. 9 and FIG. 10, the extension seats 21 can slide up and down and are connected to the inner walls of the sleeve boxes 23. The transverse sliding blocks 22 can slide left and right and are connected to inner walls of the cross rails 34. The cross rails 34 can slide up and down and are connected to the front end surfaces of the mounting seats 17. Through the installation limit of the cross rails 34, the transverse sliding blocks 22 and the extension seats 21, the driving box 18 can move up and down as well as left and right. With the cooperation of the centrifugal devices and the vertical plates 35, the centrifugal devices can be driven to work when the second threaded rods 28 rotate, and the centrifugal devices will work to drive the vertical plates 35, the cross rails 34, the transverse sliding blocks 22, the extension seats 21, the driving boxes 18, the slitting knives 20 and the like to move upward synchronously, and at the same time, the second threaded rods 28, when rotating, can drive the slitting knives 20 to move left or right due to the threaded connection with the second threaded rods 28 through the incomplete threaded seats 26; the slitting knives 20 can be moved away from the transmission roller 3 when moving upward; and when controlling the movement of the slitting knives 20, the slitting knives are prevented from contacting with the transmission roller 3, which reduces the friction between the slitting knives 20 and the transmission roller 3, thus protecting the slitting knives 20 and the transmission roller 3.

Each of the centrifugal devices includes an extension shaft 40 fixedly connected to the corresponding second threaded rod 28, and connecting pads 42 that can move left and right are respectively sleeved on outer surfaces of the extension shafts 40; connecting seats 43 slidably connected to the mounting seats 17 are rotatably connected to outer surfaces of the connecting pads 42, respectively; a connecting rod 36 is fixedly connected to an end face of one side of each of the connecting seats 43, and first sliding pins 37 are fixedly connected to inner walls of the connecting rods 36, respectively; and the vertical plates 35 are respectively provided with track grooves cooperating with the first sliding pins 37.

As shown in FIG. 10 to FIG. 12, the connecting seats 43 can slide left and right and are connected to the front end surfaces of the mounting seats 17. The extension shafts 40 are fixedly connected to end faces of one sides of the second threaded rods 28, and the outer surfaces of the extension shafts 40 are rotatably connected to bearing seats fixedly connected to the mounting seats 17, respectively. The bearing seats are configured to limit the extension shafts 40 to ensure same to only rotate. The connecting pads 42 and the extension shafts 40 are in a spline connection. The connecting pads 42 can not only move left and right on the outer surfaces of the extension shafts 40, but also are driven to rotate when the extension shafts 40 rotate. The installation and shapes of the vertical plates 35, the first sliding pins 37, and the track grooves are as shown in FIG. 11. Each of the track grooves includes a transverse slot 38 and a chute 39. When the first sliding pins 37 are engaged with the transverse slots 38, the vertical plates 35 and cross rails 34 can be limited to move up and down, that is, the heights of the slitting knives 20 are limited and fixed, the slitting knives 20 are enabled to work at specified heights, and the height positions of the slitting knives 20 are locked. When the connecting pads 42, the connecting seats 43, the connecting rods 36, the first sliding pins 37, and the like move synchronously to the right, the first sliding pins 37 will not cause the vertical plates 35 to move under the engagement of the transverse slots 38. After the first sliding pins 37 move to the right and enter inner walls of the chutes 39, the first sliding pins 37 will drive the vertical plates 35, the cross rails 34, the slitting knives 20, and the like to move synchronously upward under the engagement with the chutes 39 during the process of continuing to move to the right, that is, when the second threaded rods 28 rotate, they will drive the slitting knives 20 to move left or right and drive the vertical plates 35 to move upward. When the vertical plates 35 move upward, the slitting knives 20 will be driven to move upward, so that the slitting knives 20 are out of contact with the transmission roller 3 when moving left and right.

First tension springs 41 cooperating with the connecting pads 42 are respectively sleeved on the outer surfaces of the extension shafts 40; a plurality of evenly distributed long connecting rods 44 are respectively hinged on left end surfaces of the connecting pads 42; centrifugal discs 47 are fixedly connected to the outer surfaces of the extension shafts 40, respectively; a plurality of evenly distributed sliding seats 45 are slidably connected to inner walls of the centrifugal discs 47, respectively; and the long connecting rods 44 are respectively hinged on the corresponding sliding seats 45, and centrifugal balls 46 are fixedly connected to right ends of the sliding seats 45, respectively.

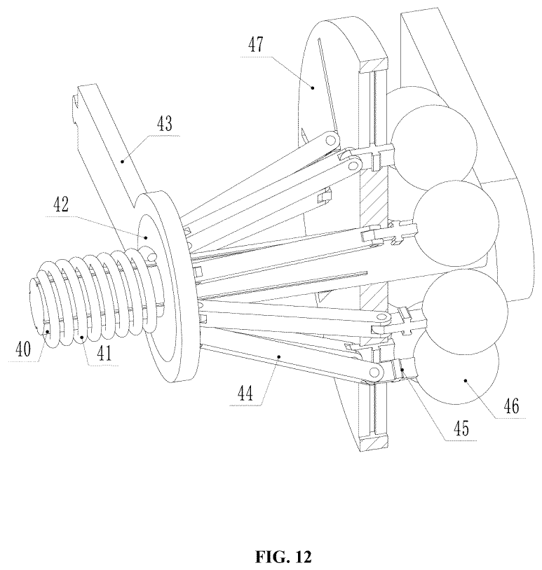

As shown in FIG. 12, one ends of the first tension springs 41 are fixedly connected to right end surfaces of the second threaded rods 28, and the other ends of the first tension springs 41 are fixedly connected to the connecting pads 42. The first tension springs 41 always exert a leftward pulling force on the connecting pads 42, so that the connecting pads 42 and the first sliding pins 37 are in the leftmost position under the normal conditions, that is, the first sliding pins 37 are engaged with the transverse slots 38 under the normal conditions for limiting and fixing the slitting knives 20. The installation and shapes of the connecting pads 42, the long connecting rods 44, the centrifugal discs 47, the sliding seats 45, and the centrifugal balls 46 are as shown in FIG. 12. The sliding seats 45 can slide inward or outward on the inner walls of the centrifugal discs 47. When the extension shafts 40 and the centrifugal discs 47 rotate, the corresponding sliding seats 45 and centrifugal balls 46 will be driven to make circular motion. When the centrifugal balls 46 make circular motion, the corresponding sliding seats 45 will be driven to move outward synchronously under the action of centrifugal force. When the sliding seats 45 move outward synchronously, one ends of the long connecting rods 44 will be driven to move outward, and the other ends of the long connecting rods 44 will pull the corresponding connecting pads 42 to move to the right. When the connecting pads 42 move to the right, the first tension springs 41 will be elongated, and the first sliding pins 37 will be driven to move to the right, so that the slitting knives 20 are enabled to move upward. When the extension shafts 40 stop rotating, the corresponding centrifugal balls 46, connecting pads 42, first sliding pins 37, and the like can be reset under the pulling force of the first tension springs 41. Due to arrangement of the centrifugal devices, regardless of whether the second threaded rods 28 and the extension shafts 40 rotate forward or backward, the first sliding pins 37 will be enabled to move to the right, that is, the vertical plates 35 and the slitting knives 20 will be enabled to move upward; and that is to say, regardless of whether the slitting knives 20 move to the left or right, the slitting knives 20 will move upward for a small distance and thus will be out of contact with the transmission roller 3.

Tension spring seats 49 are fixedly connected to the front end surfaces of the mounting seats 17, respectively; second tension springs 48 are respectively and fixedly connected to end faces of one sides the tension spring seats 49, and the other ends of the second tension springs 48 are fixedly connected to the corresponding sleeve boxes 23, respectively; long pins 29 are respectively disposed at upper ends of the incomplete threaded seats 26; and two movable linkage frames 31 are disposed at a front side of an upper end surface of the cross knife holder 16, and the linkage frames 31 are respectively provided with elongated slots 32 cooperating with the long pins 29.

As shown in FIG. 9 or FIG. 12, two telescopic rods 30 are respectively disposed at front sides of left and right ends of the upper end surface of the cross knife holder 16. The linkage frames 31 are fixedly connected to telescopic ends of the two telescopic rods 30, respectively; and the linkage frames 31 can slide back and forth and are connected to the upper end surface of the cross linkage frames 16. When the telescopic rods 30 are working, the linkage frames 31 can be driven to move inward or outward. The telescopic rods 30 belong to the prior art and will not be elaborated herein. By matching the long pins 29 with the elongated slots 32, the long pins 29 can move up and down or left and right on inner walls of the elongated slots 32. Moreover, when the linkage frames 31 move inward or outward, the long pins 29 and the incomplete threaded seats 26 will be driven to move inward or outward under the engagement between the elongated slots 32 and the long pins 29. The upper end surfaces of the incomplete threaded seats 26 are respectively provided with insertion holes, and the long pins 29 are inserted into inner walls of the insertion holes by interference fit. The long pins 29 can be disassembled, making it easy to disassemble the mounting seats 17, the driving box 18, the slitting knives 20, and the like. The installation and shapes of the tension spring seats 49 and the second tension springs 48 are as shown in FIG. 9. The second tension springs 48 always exert a leftward pulling force on the sleeve boxes 23, even if the sleeve boxes 23 can be quickly reset. When the device is idle or after use, the cross knife holder 16 is enabled to move upward for a certain distance by starting the second motors 14. Even if all the slitting knives 20 are out of contact with the transmission roller 3, at this time, by starting the telescopic rods 30, the two linkage frames 31 are driven to move outward. Even if the two incomplete threaded seats 26 move outward to disengage with the second threaded rods 28, after disengaging from the second threaded rods 28, the sleeve boxes 23, slitting knives 20 and the like can quickly move to the left and reset under the tension of the second tension springs 48.

A first motor 9 is fixedly connected to a middle part of the upper end surface of the bottom plate 1, an output end of the first motor 9 is fixedly connected to a disc 10, and a short pin 11 is fixedly connected to a non-centered part of an upper end surface of the disc 10; a surrounding box 4 is fixedly connected to inner walls of the two side supporting seats 2, and a scraper 5 cooperating with the transmission roller 3 is fixedly connected to an inner wall of the surrounding box 4; a guide plate 6 cooperating with the surrounding box 4 is slidably connected to the upper end surface of the bottom plate 1, and a long key plate 12 cooperating the short pin 11 is fixedly connected to a middle part of a lower end surface of the guide plate 6; and collection boxes 8 cooperating with the guide plate 6 are respectively placed on left and right sides of the upper end surface of the bottom plate 1.

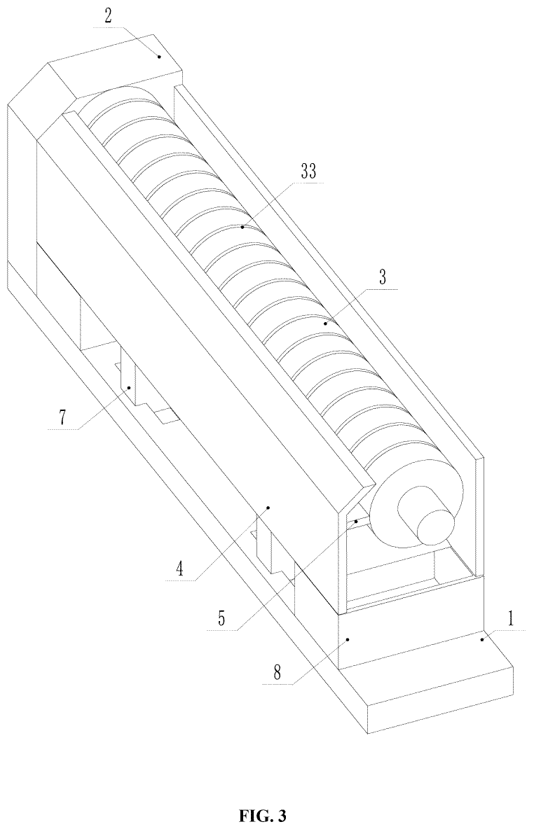

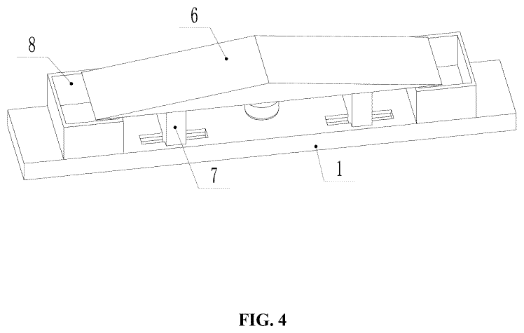

As shown in FIG. 3 to FIG. 5, the surrounding box 4 is sleeved outside the transmission roller 3 to play the role of protection and sealing; limit seats 7 are fixedly connected to left and right sides of the lower end surface of the guide plate 6, respectively; the limit seats 7 can be slide left and right and are connected to the upper end surface of the bottom plate 1; the installation and shape of the guide plate 6 are as shown in FIG. 4, with the middle being higher and the two ends being lower; and the guide plate 6 can receive the debris left after cutting, and allow same to flow into the two collection boxes 8 during movement. After cutting with the slitting knives 20, debris will inevitably be generated, and the debris will flow onto the guide plate 6 under gravity. If some of the debris is adhered to the transmission roller 3, the debris adhered onto the outer surface of the transmission roller 3 can be scraped off by the provided scraper 5 when the transmission roller 3 rotates. The first motor 9 is configured to provide rotational power for the disc 10. The installation and shapes of the long key plate 12, the short pin 11 and the disc 10 are as shown in FIG. 5. When the disc 10 rotates, the short pin 11 can be driven to rotate; and when the short pin 11 rotates, it will drive the long key plate 12 and a deflector to oscillate and move from side to side in a reciprocating manner under the engagement with the long key plate 12, so that the debris at an upper end of the deflector is enabled to flow into the collection boxes 8.

A method for using the slitting device for battery pole pieces includes the following steps:
S1, placing a lithium battery foil to be slit between the transmission roller 3 and the slitting knives 20, and allowing the lithium battery foil to be slit when the transmission roller 3 and the slitting knives 20 rotate to work; and
S2, when a slitting width needs to be changed, moving the slitting knives 20 left or right to designated positions by rotating the second threaded rods 28, and obtaining the required slitting width when the slitting knives 20 continue rotation to work.

When the present disclosure is in use, ordinate positions of the slitting knives 20 can be adjusted when the cross knife holder 16 is raised and lowered, and the mounting seats 17 are fixed onto the cross knife holder 16 by means of bolts, which allows for independent disassembly of the mounting seats 17, the slitting knives 20 and the like, thus facilitating installation and maintenance, reducing space occupation, lowering energy consumption, shortening mold changing time, and improving production efficiency. Due to arrangement of the adjusting devices, abscissa positions of the slitting knives 20 can be adjusted according to the pre-slitting requirements, that is, the left and right process width dimensions can be adjusted independently. The slitting knives 20 can rotate, and the outer surface of the transmission roller 3 is provided with the plurality of knife grooves 33 cooperating with the slitting knives 20. By allowing the lithium battery foil to pass through the position between the slitting knives 20 and the transmission roller 3, the lithium battery foil can be slit under the cooperation of the slitting knives 20 and the knife grooves 33. The device has a reduced structural space, is conducive to installation and maintenance, is simple in structure, saves materials, reduces energy consumption, and solves the problem that an all-in-one machine for pre-slitting wide foils is difficult to adjust. It can be independently disassembled for rapid tool and mold changing, thus shortening the mold changing time and improving the production efficiency.

The specific embodiments described herein are merely illustrative of the spirit of the present disclosure. Those skilled in the art to which the present disclosure pertains may make various modifications or additions or similar replacements to the described specific embodiments without departing from the spirit of the present disclosure or beyond the scope defined by the appended claims.

What is claimed is:

1. A slitting device for battery pole pieces, comprising a bottom plate (1), wherein side supporting seats (2) are respectively disposed at two sides of an upper end of the bottom plate (1), a rotatable transmission roller (3) is provided between inner sides of the two side supporting seats (2), and a liftable cross knife holder (16) is disposed at upper ends of the two side supporting seats (2); the cross knife holder (16) is provided with a plurality of detachable mounting seats (17), and rotatable slitting knives (20) are disposed at front ends of the mounting seats (17); an adjusting device is also disposed at the front end of each of the mounting seats (17) and comprises a rotatable second threaded rod (28); and the second threaded rods (28), when rotating, can form structures allowing the slitting knives (20) to move left or right.

2. The slitting device for battery pole pieces according to claim 1, wherein side frames (13) are fixedly connected to left and right sides of upper end surfaces of the side supporting seats (2), respectively; the cross knife holder (16) is slidably connected to inner walls of the two side frames (13); rear end surfaces of the side frames (13) are also fixedly connected to second motors (14), respectively; output ends of the second motors (14) are fixedly connected to first threaded rods (15), respectively; and the cross knife holder (16) is in threaded connection with outer surfaces of the two first threaded rods (15).

3. The slitting device for battery pole pieces according to claim 1, wherein a third motor (27) is fixedly connected to a front end surface of each of the mounting seats (17); the second threaded rods (28) are fixedly connected to output ends of the corresponding third motors (27), respectively; sleeve boxes (23) are respectively disposed at the front ends of the mounting seats (17), and driving boxes (18) are respectively disposed at lower ends of the sleeve boxes (23); the slitting knives (20) are respectively mounted at one sides of the driving boxes (18); and incomplete threaded seats (26) cooperating with the second threaded rods (28) are respectively provided on front and rear sides of an upper end of each of the sleeve boxes (23).

4. The slitting device for battery pole pieces according to claim 3, wherein spring seats (24) are fixedly connected to front and rear sides of an upper end surface of each of the sleeve boxes (23), respectively; first springs (25) are fixedly connected to end faces of inner sides of the two spring seats (24), respectively; the incomplete threaded seats (26) are fixedly connected to inner side ends of the corresponding first springs (25), respectively; and the incomplete threaded seats (26) are also slidably connected to the upper end surface of the sleeve box (23), respectively.

5. The slitting device for battery pole pieces according to claim 3, wherein extension seats (21) are respectively disposed at upper ends of the driving boxes (18), the extension seats (21) are slidably connected to inner walls of the sleeve boxes (23), respectively; transverse sliding blocks (22) are fixedly connected to end faces of one sides of the extension seats (21), respectively; cross rails (34) are slidably connected to the front end surfaces of the mounting seats (17), respectively; each of the transverse sliding blocks (22) is slidably connected to the corresponding cross rail (34), and a vertical plate (35) is fixedly connected to an upper end surface of each of the cross rails (34); the mounting seats (17) are also provided with centrifugal devices cooperating with the vertical plates (35), respectively; the centrifugal devices are respectively connected to the second threaded rods (28); and the second threaded rods (28), when rotating, can form structures enabling the centrifugal devices to work to move the vertical plates (35) and the slitting knives (20) upward.

6. The slitting device for battery pole pieces according to claim 5, wherein each of the centrifugal devices comprises an extension shaft (40) fixedly connected to the corresponding second threaded rod (28), and connecting pads (42) that can move left and right are respectively sleeved on outer surfaces of the extension shafts (40); connecting seats (43) slidably connected to the mounting seats (17) are rotatably connected to outer surfaces of the connecting pads (42), respectively; a connecting rod (36) is fixedly connected to an end face of one side of each of the connecting seats (43), and first sliding pins (37) are fixedly connected to inner walls of the connecting rods (36), respectively; and the vertical plates (35) are respectively provided with track grooves cooperating with the first sliding pins (37).

7. The slitting device for battery pole pieces according to claim 6, wherein first tension springs (41) cooperating with the connecting pads (42) are respectively sleeved on the outer surfaces of the extension shafts (40); a plurality of evenly distributed long connecting rods (44) are respectively hinged on left end surfaces of the connecting pads (42); centrifugal discs (47) are fixedly connected to the outer surfaces of the extension shafts (40), respectively; a plurality of evenly distributed sliding seats (45) are slidably connected to inner walls of the centrifugal discs (47), respectively; and the long connecting rods (44) are respectively hinged on the corresponding sliding seats (45), and centrifugal balls (46) are fixedly connected to right ends of the sliding seats (45), respectively.

8. The slitting device for battery pole pieces according to claim 3, wherein tension spring seats (49) are fixedly connected to the front end surfaces of the mounting seats (17), respectively; second tension springs (48) are respectively and fixedly connected to end faces of one sides the tension spring seats (49), and the other ends of the second tension springs (48) are fixedly connected to the corresponding sleeve boxes (23), respectively; long pins (29) are respectively disposed at upper ends of the incomplete threaded seats (26); and two movable linkage frames (31) are disposed at a front side of an upper end surface of the cross knife holder (16), and the linkage frames (31) are respectively provided with elongated slots (32) cooperating with the long pins (29).

9. The slitting device for battery pole pieces according to claim 1, wherein a first motor (9) is fixedly connected to a middle part of an upper end surface of the bottom plate (1), an output end of the first motor (9) is fixedly connected to a disc (10), and a short pin (11) is fixedly connected to a non-centered part of an upper end surface of the disc (10); a surrounding box (4) is fixedly connected to inner walls of the two side supporting seats (2), and a scraper (5) cooperating with the transmission roller (3) is fixedly connected to an inner wall of the surrounding box (4); a guide plate (6) cooperating with the surrounding box (4) is slidably connected to the upper end surface of the bottom plate (1), and a long key plate (12) cooperating the short pin (11) is fixedly connected to a middle part of a lower end surface of the guide plate (6); and collection boxes (8) cooperating with the guide plate (6) are respectively placed on left and right sides of the upper end surface of the bottom plate (1).

10. A method for using the slitting device for battery pole pieces according to claim 1, wherein the method comprises the following steps:
S1, placing a lithium battery foil to be slit between the transmission roller (3) and the slitting knives (20), and allowing the lithium battery foil to be slit when the transmission roller (3) and the slitting knives (20) rotate to work; and
S2, when a slitting width needs to be changed, moving the slitting knives (20) left or right to designated positions by rotating the second threaded rods (28), and obtaining the required slitting width when the slitting knives (20) continue rotation to work.
